(19) United States
(12) Patent Application Publication
(10) Pub. No.: US 2018/0053381 A1
(43) Pub. Date: Feb. 22, 2018

(54) Modified Blackjack Game

(71) Applicant: Padrino Gaming Corp., Winnipeg (CA)

(72) Inventor: Kelvin Morin, Winnipeg (CA)

(21) Appl. No.: 15/642,841

(22) Filed: Jul. 6, 2017

Related U.S. Application Data
(60) Provisional application No. 62/375,541, filed on Aug. 16, 2016.

(51) Int. Cl. G07F 17/32; A63F 1/00

(52) U.S. Cl. CPC G07F 17/3293; A63F 2001/003; A63F 1/00

(57) ABSTRACT

The modified blackjack game uses a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9. In a preferred embodiment, all bets are resolved and there are no ties. The player wins on ties higher than 19 and loses on ties of 18 and 17. To alleviate the loss that players incur on ties of 17 and 18, there will be two separate wagers offered for when the dealer draws a 17 and 18. Two additional bets are offered for when the dealer makes a blackjack and busts.

This application claims the benefit under 35 U.S.C. 119(e) of U.S. provisional application Ser. No. 62/375,541, filed Aug. 16, 2016.

### FIELD OF THE INVENTION

The present invention relates to casino table and electronic video wagering games based on playing cards, particularly casino games based on blackjack, and most particularly casino table card games that may have a modified deck of playing cards.

### BACKGROUND

According to Wikipedia (https://en.wikipedia.org/wiki/Blackjack): “Blackjack, also known as twenty-one, is the most widely played casino banking game in the world. Blackjack is a comparing card game between a player and dealer, meaning players compete against the dealer but not against other players. It is played with one or more decks of 52 cards. The objective of the game is to beat the dealer in one of the following ways: i) Get 21 points on the player's first two cards (called a “blackjack” or “natural”), without a dealer blackjack; ii) Reach a final score higher than the dealer without exceeding 21; or iii) Let the dealer draw additional cards until his or her hand exceeds 21.

The player or players are dealt a two-card hand and add together the value of their cards. Face cards (kings, queens, and jacks) are counted as ten points. A player and the dealer can count an ace as 1 point or 11 points. All other cards are counted as the numeric value shown on the card. After receiving their first two cards, players have the option of getting a “hit”, or taking an additional card. In a given round, the player or the dealer wins by having a score of 21 or by having the higher score that is less than 21. Scoring higher than 21 (called “busting” or “going bust”) results in a loss. A player may win by having any final score equal to or less than 21 if the dealer busts. If a player holds an ace valued as 11, the hand is called “soft”, meaning that the player cannot go bust by taking an additional card; 11 plus the value of any other card will always be less than or equal to 21. Otherwise, the hand is “hard”.

The dealer must hit until the cards total 17 or more points. (At many tables the dealer also hits on a “soft” 17, i.e. a hand containing an ace and one or more other cards totaling six.) Players win by not busting and having a total higher than the dealer's. The dealer loses by busting or having a lesser hand than the player who has not busted. If the player and dealer have the same total, this is called a “push”, and the player typically does not win or lose money on that hand. If all available players bust, the hand ends automatically without the dealer having to play his or her hand.

Blackjack has many rule variations. Since the 1960s, blackjack has been a high-profile target of advantage players, particularly card counters, who track the profile of cards that have been dealt and adapt their wagers and playing strategies accordingly.

At a casino blackjack table, the dealer faces five to seven playing positions from behind a semicircular table. Between one and eight standard 52-card decks are shuffled together. At the beginning of each round, up to three players can place their bets in the “betting box” at each position in play. That is, there could be up to three players at each position at a table in jurisdictions that allow back betting. The player whose bet is at the front of the betting box is deemed to have control over the position, and the dealer will consult the controlling player for playing decisions regarding the hand; the other players of that box are said to “play behind”. Any player is usually allowed to control or bet in as many boxes as desired at a single table, but it is prohibited for an individual to play on more than one table at a time or to place multiple bets within a single box. In many U.S. casinos, however, players are limited to playing two or three positions at a table and often only one person is allowed to bet on each position.

The dealer deals cards from his/her left (the position on the dealer's far left is often referred to as “first base”) to his/her far right (“third base”). Each box is dealt an initial hand of two cards visible to the people playing on it, and often to any other players. The dealer's hand receives its first card face up, and in “hole card” games immediately receives its second card face down (the hole card), which the dealer peeks at but does not reveal unless it makes the dealer's hand a blackjack. Hole card games are sometimes played on tables with a small mirror or electronic sensor that is used to peek securely at the hole card. In European casinos, “no hole card” games are prevalent; the dealer's second card is neither drawn nor consulted until the players have all played their hands.

Cards are dealt either from one or two handheld decks, from a dealer's show, or from a shuffling machine. Single cards are dealt to each wagered-on position clockwise from the dealer's left, followed by a single card to the dealer, followed by an additional card to each of the positions in play. The players' initial cards may be dealt face up or face down (more common in single-deck games).

The players' object is to win money by creating card totals that turn out to be higher than the dealer's hand but do not exceed 21 (“busting”/“breaking”), or alternatively by allowing the dealer to take additional cards until he/she busts. On their turn, players must choose whether to “hit” (take a card), “stand” (end their turn), “double” (double wager, take a single card and finish), “split” (if the two cards have the same value, separate them to make two hands) or “surrender” (give up a half-bet and retire from the game). Number cards count as their natural value; the jack, queen, and king (also known as “face cards” or “pictures”) count as 10; aces are valued as either 1 or 11 according to the player's choice. If the hand value exceeds 21 points, it busts, and all bets on it are immediately forfeit. After all boxes have finished playing, the dealer's hand is resolved by drawing cards until the hand busts or achieves a value of 17 or higher (a dealer total of 17 including an ace, or “soft 17”, must be drawn to in some games and must stand in others). The dealer never doubles, splits, or surrenders. If the dealer busts, all remaining player hands win. If the dealer does not bust, each remaining bet wins if its hand is higher than the dealer's, and loses if it is lower. If a player receives 21 on the 1st and 2nd card it is considered a “natural 21” or “blackjack” and the player is paid out immediately unless dealer also has a natural, in which case the hand ties. In the case of a tied score, known as “push” or “standoff”, bets are normally returned without adjustment; however, a blackjack beats any hand that is not a blackjack, even one with a value of 21. An outcome of blackjack vs. blackjack results in a push. Wins are paid out at 1:1, or equal to the wager, except for winning blackjacks, which are traditionally paid at 3:2 (meaning the player receives three dollars for every two bet), or one-and-a-half times the wager. Many casinos today pay blackjacks at less than 3:2 at some tables; for instance, single-deck blackjack tables often pay 6:5 for a blackjack instead of 3:2.

Blackjack games almost always provide a side bet called insurance, which may be played when dealer's upcard is an ace. Additional side bets, such as “Dealer Match” which pays when the player's cards match the dealer's up card, are sometimes available.

Player Decisions:

After receiving an initial two cards, the player has up to four standard options: “hit”, “stand”, “double down”, or “split”. Each option has a corresponding hand signal. Some games give the player a fifth option, “surrender”.

i) Hit: Take another card from the dealer; Signal: Scrape cards against table (in handheld games), tap the table with finger or wave hand toward body (in games dealt face up).

ii) Stand: Take no more cards, also known as “stand pat”, “stick”, or “stay”; Signal: Slide cards under chips (in handheld games), wave hand horizontally (in games dealt face up).

iii) Double down: The player is allowed to increase the initial bet by up to 100% in exchange for committing to stand after receiving exactly one more card. The additional bet is placed in the betting box next to the original bet. Some games do not permit the player to increase the bet by amounts other than 100%. Non-controlling players may double their wager or decline to do so, but they are bound by the controlling player's decision to take only one card. Signal: Place additional chips beside the original bet outside the betting box, and point with one finger.

iv) Split: If the first two cards of a hand have the same value, the player can split them into two hands, by moving a second bet equal to the first into an area outside the betting box. The dealer separates the two cards and draws an additional card on each, placing one bet with each hand. The player then plays out the two separate hands in turn; except for a few restrictions, the hands are treated as independent new hands, with the player winning or losing their wager separately for each hand. Occasionally, in the case of ten-valued cards, some casinos allow splitting only when the cards have the identical ranks; for instance, a hand of 10-10 may be split, but not one of 10-king. However, usually all 10-value cards are treated the same. Doubling and further splitting of post-split hands may be restricted, and blackjacks after a split are counted as non-blackjack 21 when comparing against the dealer's hand. Hitting split aces is usually not allowed. Non-controlling players may follow the controlling player by putting down an additional bet or decline to do so, instead associating their existing wager with one of the two post-split hands. In that case they must choose which hand to play behind before the second cards are drawn. Some casinos do not give non-controlling players this option, and require that the wager of a player not electing to split remains with the first of the two post-split hands. Signal: Place additional chips next to the original bet outside the betting box; point with two fingers spread into a V formation.

v) Surrender (only available as first decision of a hand): Some games offer the option to “surrender”, usually in hole-card games and directly after the dealer has checked for blackjack (but see below for variations). When the player surrenders, the house takes half the player's bet and returns the other half to the player; this terminates the player's interest in the hand. Signal: The request to surrender is made verbally, there being no standard hand signal.

Hand signals are used to assist the “eye in the sky”, a person or video camera located above the table and sometimes concealed behind one-way glass. The eye in the sky usually makes a video recording of the table, which helps in resolving disputes and identifying dealer mistakes, and is also used to protect the casino against dealers who steal chips or players who cheat. The recording can further be used to identify advantage players whose activities, while legal, make them undesirable customers. In the event of a disagreement between a player's hand signals and their words, the hand signal takes precedence.

Each hand may normally “hit” as many times as desired so long as the total is not above hard 20. On reaching 21 (including soft 21), the hand is normally required to stand; busting is an irrevocable loss and the players' wagers are immediately forfeited to the house. After a bust or a stand, play proceeds to the next hand clockwise around the table. When the last hand has finished being played, the dealer reveals the hole card, and stands or draws further cards according to the rules of the game for dealer drawing. When the outcome of the dealer's hand is established, any hands with bets remaining on the table are resolved (usually in counterclockwise order): bets on losing hands are forfeited, the bet on a push is left on the table, and winners are paid out.

Insurance:

If the dealer's upcard is an ace, the player is offered the option of taking “insurance” before the dealer checks the hole card.

Insurance is a side bet that the dealer has blackjack and is treated independently of the main wager. It pays 2:1 (meaning that the player receives two dollars for every dollar bet) and is available when the dealer's exposed card is an ace. The idea is that the dealer's second card has a fairly high probability (nearly one-third) to be ten-valued, giving the dealer blackjack and disappointment for the player. It is attractive (although not necessarily wise) for the player to insure against the possibility of a dealer blackjack by making a maximum “insurance” bet, in which case the “insurance proceeds” will make up for the concomitant loss on the original bet. The player may add up to half the value of their original bet to the insurance and these extra chips are placed on a portion of the table usually marked “Insurance pays 2 to 1”.

Players with a blackjack may also take insurance, and in taking maximum insurance they commit themselves to winning an amount exactly equal to their main wager, regardless of the dealer's outcome. Fully insuring a blackjack against blackjack is thus referred to as “taking even money”, and paid out immediately, before the dealer's hand is resolved; the players do not need to place more chips for the insurance wager.

Insurance bets are expected to lose money in the long run, because the dealer is likely to have blackjack less than one-third of the time. However, the insurance outcome is strongly anti-correlated with that of the main wager, and if the player's priority is to reduce variation, they might choose to pay for this.

Furthermore, the insurance bet is susceptible to advantage play. It is advantageous to make an insurance bet whenever the hole card has more than a chance of one in three of being a ten. Advantage play techniques can sometimes identify such situations. In a multi-hand, face-up, single deck game, it is possible to establish whether insurance is a good bet simply by observing the other cards on the table after the deal; even if there are just 2 player hands exposed, and neither of their two initial cards is a ten, then 16 in 47 of the remaining cards are tens, which is larger than 1 in 3, so insurance is a good bet. This is an elementary example of the family of advantage play techniques known as card counting.

Bets to insure against blackjack are slightly less likely to be advantageous than insurance bets in general, since the ten in the player's blackjack makes it less likely that the dealer has blackjack too.

Rule Variations and their Consequences for the House Edge:

The rules of casino blackjack are generally determined by law or regulation, which establishes certain rule variations allowed at the discretion of the casino. The rules of any particular game are generally posted on or near the table, failing which there is an expectation that casino staff will provide them on request. Over 100 variations of blackjack have been documented.

As with all casino games, blackjack incorporates a “house edge”, a statistical advantage for the casino that is built into the game. The advantage of the dealer's position in blackjack relative to the player comes from the fact that if the player busts, the player loses, regardless of whether the dealer subsequently busts. Nonetheless, blackjack players using basic strategy will lose less than 1% of their total wagered amount with strictly average luck; this is very favorable to the player compared to other casino games. The loss rate of players who deviate from basic strategy through ignorance is generally expected to be greater.

Dealer Hits Soft 17:

Each game has a rule about whether the dealer must hit or stand on soft 17, which is generally printed on the table surface. The variation where the dealer must hit soft 17 is abbreviated “H17” in blackjack literature, with “S17” used for the stand-on-soft-17 variation. Substituting an “H17” rule with an “S17” rule in a game benefits the player, decreasing the house edge by about 0.2%

Number of Decks:

All things being equal, using fewer decks decreases the house edge. This mainly reflects an increased likelihood of player blackjack, since if the players draws a ten on their first card, the subsequent probability of drawing an ace is higher with fewer decks. It also reflects a decreased likelihood of blackjack-blackjack push in a game with fewer decks.

Casinos generally compensate by tightening other rules in games with fewer decks, in order to preserve the house edge or discourage play altogether. When offering single deck blackjack games, casinos are more likely to disallow doubling on soft hands or after splitting, to restrict resplitting, require higher minimum bets, and to pay the player less than 3:2 for a winning blackjack.

Late/Early Surrender:

Surrender, for those games that allow it, is usually not permitted against a dealer blackjack; if the dealer's first card is an ace or ten, the hole card is checked to make sure there is no blackjack before surrender is offered. This rule protocol is consequently known as “late” surrender. The alternative, “early” surrender, gives player the option to surrender before the dealer checks for blackjack, or in a no-hole-card game. Early surrender is much more favorable to the player than late surrender. Most medium-strength hands should be surrendered against a dealer Ace if the hole card has not been checked.

For late surrender, however, while it is tempting opt for surrender on any hand which will probably lose, the correct strategy is to only surrender on the very worst hands, because having even a one in four chance of winning the full bet is better than losing half the bet and pushing the other half, as entailed by surrendering.

Resplitting:

If the cards of a post-split hand have the same value, most games allow the player to split again, or “resplit”. The player places a further wager and the dealer separates the new pair dealing a further card to each as before. Some games allow unlimited resplitting, while others may limit it to a certain number of hands, such as four hands (for example, “resplit to 4”).

Hit/Resplit Split Aces:

After splitting aces, the common rule is that only one card will be dealt to each ace; the player cannot split, double, or take another hit on either hand. Rule variants include allowing resplitting aces or allowing the player to hit split aces. Games allowing aces to be resplit are not uncommon, but those allowing the player to hit split aces are extremely rare. Allowing the player to hit hands resulting from split aces reduces the house edge by about 0.13%; allowing resplitting of aces reduces house edge by about 0.03%. Note that a ten-value card dealt on a split ace (or vice versa) is a “soft 21” and not a “natural”.

No Double after Split:

After a split, most games allow doubling down on the new two-card hands. Disallowing doubling after a split increases the house edge by about 0.12%.

Double on 9/10/11 or 10/11 only: Under the “Reno rule”, double down is only permitted on hard totals of 9, 10, or 11 (under a similar European rule, only 10 or 11). Basic strategy would otherwise call for some doubling down with hard 9 and soft 13-18, and advanced players can identify situations where doubling on soft 19-20 and hard 8,7 and even 6 is advantageous. The Reno rule prevents the player from taking advantage of double down in these situations and thereby increases the player's expected loss. The Reno rule increases the house edge by around one in 1000, and its European version by around two in 1000.

No Hole Card and OBO:

In most non-U.S. casinos, a ‘no hole card’ game is played, meaning that the dealer does not draw nor consult his or her second card until after all players have finished making decisions. With no hole card, it is almost never correct basic strategy to double or split against a dealer ten or ace, since a dealer blackjack will result in the loss of the split and double bets; the only exception is with a pair of A's against a dealer 10, where it is still correct to split. In all other cases, a stand, hit or surrender is called for. For instance, holding 11 against a dealer 10, the correct strategy is to double in a hole card game (where the player knows the dealer's second card is not an ace), but to hit in a no hole card game. The no hole card rule adds approximately 0.11% to the house edge.

The “original bets only” rule variation appearing in certain no hole card games states that if the player's hand loses to a dealer blackjack, only the mandatory initial bet (“original”) is forfeited, and all optional bets, meaning doubles and splits, are pushed. “Original bets only” is also known by the acronym OBO; it has the same effect on basic strategy and house edge as reverting to a hole card game.

Altered Payout for a Winning Blackjack:

In many casinos, a blackjack pays only 6:5 or even 1:1 instead of the usual 3:2. This is usually at tables with the lowest table minimums and single-deck games. Among common rule variations in the U.S., these altered payouts for blackjack are the most damaging to the player, causing the greatest increase in house edge. Since blackjack occurs in approximately 4.8% of hands, the 1:1 game increases the house edge by 2.3%, while the 6:5 game adds 1.4% to the house edge. Video blackjack machines generally pay 1:1 payout for a blackjack. The 6:5 rule is most commonly employed on table blackjack at single deck games, where they help the house to compensate for low house edge intrinsic in using one deck only.”

### SUMMARY OF THE INVENTION

According to one aspect of the invention there is provided a method of playing a card wagering game between a player and a dealer, the method comprising:

providing a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9;

receiving an initial wager from the player;

dealing the player two initial player cards from the modified combined deck;

dealing the dealer two initial dealer cards from the modified combined deck;

displaying a first one of the two initial dealer cards to the player;

dealing one or more additional player cards from the modified combined deck to the player in response to a request by the player;

dealing additional dealer cards from the modified combined deck to the dealer until a summation of the dealer cards exceeds sixteen;

collecting the initial wager from the player if:
i) a sum of the player cards exceeds 21; or
ii) a sum of the dealer cards is below 22 and the sum of the dealer cards exceeds the sum of the player cards; and

paying a winning amount to the player on the initial wager if:
i) the sum of the dealer cards exceeds 21 and the sum of the player cards is less than 22;
ii) the sum of the player cards is below 22 and the sum of the player cards exceeds the sum of the dealer cards; or
iii) the sum of the player cards and the sum of the dealer cards are equal to one another and equal to at least one prescribed winning number which is less than 22.

The prescribed winning number may be greater than 18, and more preferably includes 19, 20 and 21, including blackjack.

Alternatively, the initial wager may be collected from the player if the sum of the player cards and the sum of the dealer cards are equal to one another and equal to at least one prescribed losing number which is less than 19. Preferably the prescribed losing number includes 17 and 18.

Optionally, when an auxiliary wager is received from the player, the method may include i) paying a winning amount to the player on the auxiliary wager if the sum of the dealer is equal to the prescribed losing number; ii) paying a winning amount to the player on the auxiliary wager if the sum of the two initial dealer cards is 21 (i.e. dealer blackjack), and/or iii) paying a winning amount to the player on the auxiliary wager if the sum of the dealer cards is greater than 21 (i.e. dealer bust).

Preferably the number of standard runs and the number of modified runs in the modified combined deck are equal to one another. For example, three standard decks and three modified decks may be combined such that there are twelve standard runs and twelves modified runs overall.

Preferably all ties between the sum of the player cards and the sum of the dealer cards are resolved by either i) collecting the initial wager from the player, or ii) paying a winning amount to the player on the initial wager.

In some embodiments, the modified combined deck comprises a virtual deck in a video gaming system and wherein the cards comprise virtual cards which are dealt to the player on a virtual card table displayed on an electronic display.

In alternative embodiments, the modified combined deck comprises physical playing cards which are shuffled and dealt to the player on a physical card table.

The method preferably includes dealing the additional dealer cards from the modified combined deck to the dealer until: i) a summation of the dealer cards exceeds sixteen when any aces in the dealer cards are counted as 1, or ii) a summation of the dealer cards exceeds 17 when an ace in the dealer cards is counted as 11.

Optionally, the method may include returning half of the initial wager to the player if the player chooses to surrender subsequent to displaying the first one of the two initial dealer cards to the player.

According to a second aspect of the present invention there is provided a method of playing a card wagering game between a player and a dealer, the method comprising:

providing a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9;

receiving an initial wager from the player;

dealing the player two initial player cards from the modified combined deck;

dealing the dealer two initial dealer cards from the modified combined deck;

displaying a first one of the two initial dealer cards to the player;

dealing one or more additional player cards from the modified combined deck to the player in response to a request by the player;

dealing additional dealer cards from the modified combined deck to the dealer until a summation of the dealer cards exceeds sixteen;

collecting the initial wager from the player if:
i) a sum of the player cards exceeds 21;
ii) a sum of the dealer cards is below 22 and the sum of the dealer cards exceeds the sum of the player cards; or
iii) the sum of the player cards and the sum of the dealer cards are equal to one another and equal to at least one prescribed losing number; and

paying a winning amount to the player on the initial wager if:
i) the sum of the dealer cards exceeds 21 and the sum of the player cards is less than 22; or
ii) the sum of the player cards is below 22 and the sum of the player cards exceeds the sum of the dealer cards.

According to a third aspect of the present invention there is provided a method of playing a card wagering game between a player and a dealer, the method comprising:

providing a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9;

receiving an initial wager from the player;

dealing the player two initial player cards from the modified combined deck;

dealing the dealer two initial dealer cards from the modified combined deck;

displaying a first one of the two initial dealer cards to the player;

dealing one or more additional player cards from the modified combined deck to the player in response to a request by the player;

dealing additional dealer cards from the modified combined deck to the dealer until a summation of the dealer cards exceeds sixteen;

collecting the initial wager from the player if:
i) a sum of the player cards exceeds 21; or
ii) a sum of the dealer cards is below 22 and the sum of the dealer cards exceeds the sum of the player cards;

paying a winning amount to the player on the initial wager if:
i) the sum of the dealer cards exceeds 21 and the sum of the player cards is less than 22; or
ii) the sum of the player cards is below 22 and the sum of the player cards exceeds the sum of the dealer cards; and

resolving each tie between the sum of the player cards and the sum of the dealer cards by either i) collecting the initial wager from the player, or ii) paying a winning amount to the player on the initial wager according to the value of the tie.

### BRIEF DESCRIPTION OF THE DRAWINGS

Some embodiments of the invention will now be described in conjunction with the accompanying drawings in which:

FIG. 1 is chart summarizing the composition of the modified combined deck;

FIG. 2 is a chart summarizing the strategy of the game in which H=Hit, S=Stand, D=Double, P=Split, and R=Surrender;

FIG. 3 is a chart summarizing the house edge on the initial player wager in the game; and

FIG. 4 is a chart summarizing the house edge on each independent optional wager in the game.

In the drawings like characters of reference indicate corresponding parts in the different figures.

### DETAILED DESCRIPTION

The modified blackjack game according to the present invention is referred to herein as “Big Tie Blackjack” (BTBJ). BTBJ (Big Tie Blackjack) is a game that is played like a standard game of blackjack, but with more liberal rules and there are no ties against the dealer hand (“pushed” hands). All hands are resolved.

Winning Ties:

In the game of BTBJ, the player wins on ties higher than 19 and loses on ties of 18 and 17.

If a tie over 18 occurs, the player's bet(s) wins and is paid according to the flowing pay table:

| | |
|---|---|
| Tie on 19 | Pays Odds of 3 to 2 |
| Tie on 20 | Pays Odds of 1 to 1 |
| Tie on 21 | Pays Odds of 3 to 1 |
| Tie on Blackjack | Pays Odds of 4 to 1 |

Standard Game Rules:

Like standard blackjack, all other hands are resolved per standard blackjack with the following rules:

i) Winning Blackjack hand (21 on first two cards dealt) is paid at odds of 3 to 2;

ii) Dealer will draw to a soft 17 and hard 16;

iii) Player loses only original bet on dealer Blackjack (American Hole-card rules);

iv) Double on any total;

v) Double after splitting allowed;

vi) Split 3 times to make 4 hands; and

v) No Insurance bet offered.

Additional Rules:

The following additional rules are implemented:

i) Play may double on any number of cards;

ii) Early Surrender: Player may Surrender their bet for half before the dealer checks for BJ, even when dealer showing an Ace; and

iii) Player allowed to Hit, Re-Split, Double and Surrender on Split Aces.

Deck Composition:

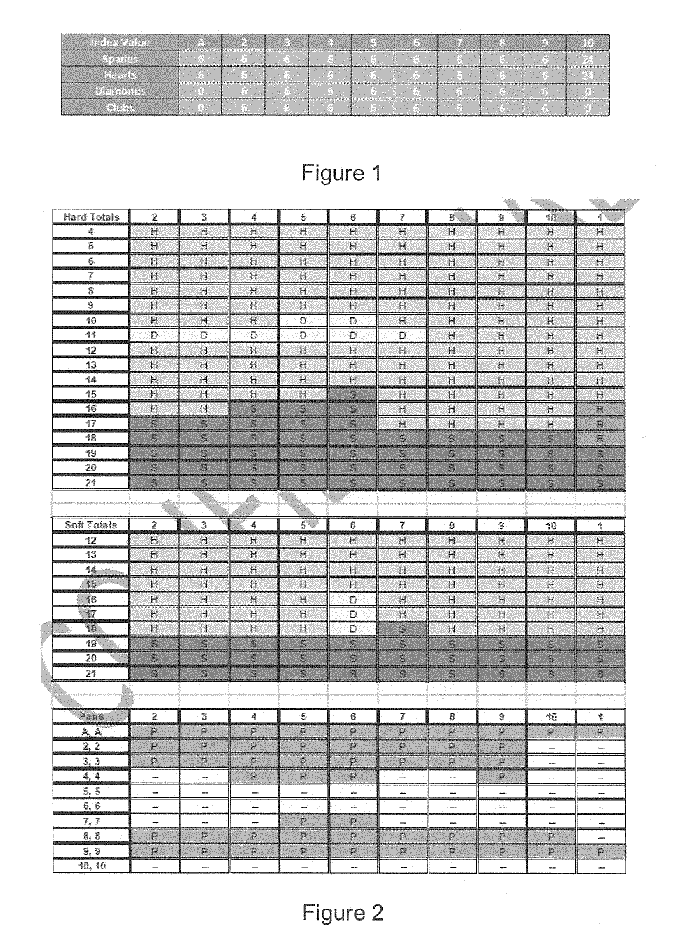

BTBJ is played with a modified deck (à la Spanish 21) where the deck is composed of 252 cards. The 10's thru Aces for Diamonds and Clubs are removed. A summary of the deck composition is shown in FIG. 1.

Optional Wagering:

To alleviate the loss that players incur on ties of 17 and 18, there will be two separate wagers offered for when the dealer draws a 17 and 18. Two additional bets are offered for when the dealer makes a blackjack and busts. All bets are resolved upon completion of the dealer hand according to the following.

| | |
|---|---|
| Dealer draws to 17 | Pays Odds of 5 to 1 |
| Dealer draws to 18 | Pays Odds of 5 to 1 |
| Dealer Blackjack | Pays Odds of 40 to 1 |
| Dealer Bust | Pays Odds of 2 to 1 |

House Edge:

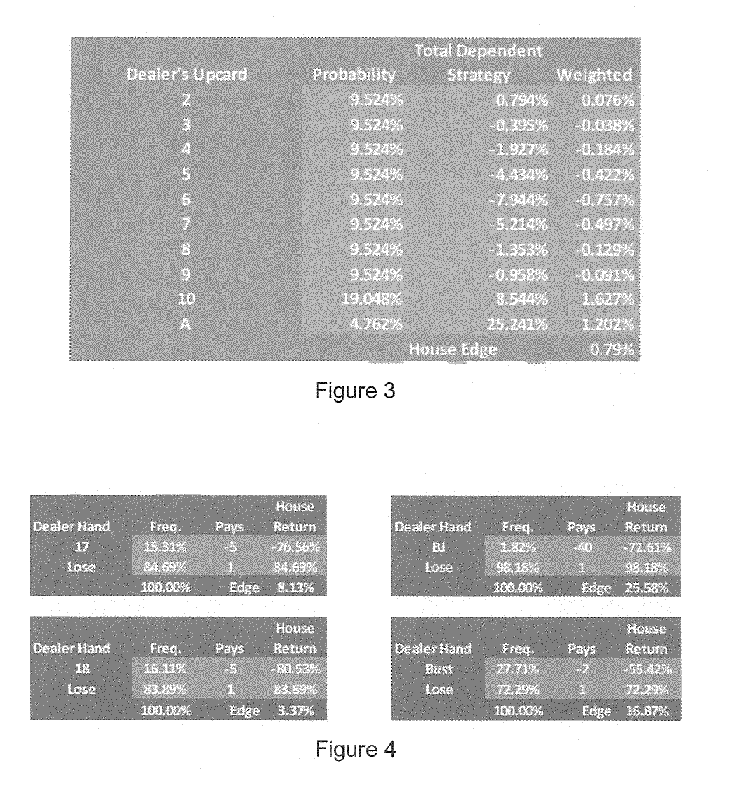

The optimal “Total Dependent” strategy (strategy that does not consider the specific cards in the hand) yields a house edge as summarized in FIG. 3.

As with most blackjack games that utilize a high number of decks, the card dependent strategies (strategies that factor in the exact cards rather than the overall total) have very little impact on the house edge. Using such a comprehensive strategy would yield the player an additional ˜0.005% off the edge shown above, reducing it to ˜0.785%.

Cost of Error:

Players will typically play this game as they would standard blackjack. Assuming that they do, the approximate house edge over the player would be in the range of 5-6%.

Optional Wagers House Edge:

A brute force approach was taken to determine the dealer hand frequencies, using a 10 million hand simulation. The house edge on each independent wager is summarized in FIG. 4.

Since various modifications can be made in my invention as herein above described, and many apparently widely different embodiments of same made, it is intended that all matter contained in the accompanying specification shall be interpreted as illustrative only and not in a limiting sense.

1. A method of playing a card wagering game between a player and a dealer, the method comprising:
providing a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9;
receiving an initial wager from the player;
dealing the player two initial player cards from the modified combined deck;
dealing the dealer two initial dealer cards from the modified combined deck;
displaying a first one of the two initial dealer cards to the player;
dealing one or more additional player cards from the modified combined deck to the player in response to a request by the player;
dealing additional dealer cards from the modified combined deck to the dealer until a summation of the dealer cards exceeds sixteen;
collecting the initial wager from the player if:
i) a sum of the player cards exceeds 21; or
ii) a sum of the dealer cards is below 22 and the sum of the dealer cards exceeds the sum of the player cards; and
paying a winning amount to the player on the initial wager if:
i) the sum of the dealer cards exceeds 21 and the sum of the player cards is less than 22;
ii) the sum of the player cards is below 22 and the sum of the player cards exceeds the sum of the dealer cards; or
iii) the sum of the player cards and the sum of the dealer cards are equal to one another and equal to at least one prescribed winning number which is less than 22.

2. The method according to claim 1 wherein said at least one prescribed winning number is greater than 18.

3. The method according to claim 1 wherein said at least one prescribed winning number includes 21.

4. The method according to claim 1 wherein said at least one prescribed winning number includes 20.

5. The method according to claim 1 wherein said at least one prescribed winning number includes 19.

6. The method according to claim 1 including collecting the initial wager from the player if the sum of the player cards and the sum of the dealer cards are equal to one another and equal to at least one prescribed losing number which is less than 19.

7. The method according to claim 6 wherein said at least one prescribed losing number includes 18.

8. The method according to claim 6 wherein the prescribed losing number includes 17.

9. The method according to claim 6 including receiving an auxiliary wager from the player and paying a winning amount to the player on the auxiliary wager if the sum of the dealer is equal to the prescribed losing number.

10. The method according to claim 1 including receiving an auxiliary wager from the player and paying a winning amount to the player on the auxiliary wager if the sum of the two initial dealer cards is 21.

11. The method according to claim 1 including receiving an auxiliary wager from the player and paying a winning amount to the player on the auxiliary wager if the sum of the dealer cards is greater than 21.

12. The method according to claim 1 wherein a number of standard runs and a number of modified runs in the modified combined deck are equal to one another.

13. The method according to claim 1 wherein all ties between the sum of the player cards and the sum of the dealer cards are resolved by either i) collecting the initial wager from the player, or ii) paying a winning amount to the player on the initial wager.

14. The method according to claim 1 wherein the modified combined deck comprises a virtual deck in a video gaming system and wherein the cards comprise virtual cards which are dealt to the player on a virtual card table displayed on an electronic display.

15. The method according to claim 1 wherein the modified combined deck comprises physical playing cards which are shuffled and dealt to the player on a physical card table.

16. The method according to claim 1 including dealing the additional dealer cards from the modified combined deck to the dealer until: i) a summation of the dealer cards exceeds sixteen when any aces in the dealer cards are counted as 1, or ii) a summation of the dealer cards exceeds 17 when an ace in the dealer cards is counted as 11.

17. The method according to claim 1 including returning half of the initial wager to the player if the player chooses to surrender subsequent to displaying the first one of the two initial dealer cards to the player.

19. A method of playing a card wagering game between a player and a dealer, the method comprising:
providing a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9;
receiving an initial wager from the player;
dealing the player two initial player cards from the modified combined deck;
dealing the dealer two initial dealer cards from the modified combined deck;
displaying a first one of the two initial dealer cards to the player;
dealing one or more additional player cards from the modified combined deck to the player in response to a request by the player;
dealing additional dealer cards from the modified combined deck to the dealer until a summation of the dealer cards exceeds sixteen;
collecting the initial wager from the player if:
i) a sum of the player cards exceeds 21;
ii) a sum of the dealer cards is below 22 and the sum of the dealer cards exceeds the sum of the player cards; or
iii) the sum of the player cards and the sum of the dealer cards are equal to one another and equal to at least one prescribed losing number; and
paying a winning amount to the player on the initial wager if:
i) the sum of the dealer cards exceeds 21 and the sum of the player cards is less than 22; or
ii) the sum of the player cards is below 22 and the sum of the player cards exceeds the sum of the dealer cards.

20. A method of playing a card wagering game between a player and a dealer, the method comprising:
providing a modified combined deck consisting of: i) at least one standard run of cards consisting of one card numbered according to each of the values from 2 to 9, four cards having a value of 10 and one ace card having a value of either 1 or 11, and ii) at least one modified run of cards consisting of one card numbered according to each of the values from 2 to 9;
receiving an initial wager from the player;
dealing the player two initial player cards from the modified combined deck;
dealing the dealer two initial dealer cards from the modified combined deck;
displaying a first one of the two initial dealer cards to the player;
dealing one or more additional player cards from the modified combined deck to the player in response to a request by the player;
dealing additional dealer cards from the modified combined deck to the dealer until a summation of the dealer cards exceeds sixteen;
collecting the initial wager from the player if:
i) a sum of the player cards exceeds 21; or
ii) a sum of the dealer cards is below 22 and the sum of the dealer cards exceeds the sum of the player cards;
paying a winning amount to the player on the initial wager if:
i) the sum of the dealer cards exceeds 21 and the sum of the player cards is less than 22; or
ii) the sum of the player cards is below 22 and the sum of the player cards exceeds the sum of the dealer cards; and
resolving each tie between the sum of the player cards and the sum of the dealer cards by either i) collecting the initial wager from the player, or ii) paying a winning amount to the player on the initial wager according to the value of the tie.
